(19) United States
(12) Patent Application Publication
(10) Pub. No.: US 2001/0030169 A1
(43) Pub. Date: Oct. 18, 2001

(54) Method of etching organic film and method of producing element

(76) Inventors: Hideo Kitagawa, Utsunomiya-shi (JP); Nobumasa Suzuki, Yokohama-shi (JP)

Correspondence Address: FITZPATRICK CELLA HARPER & SCINTO, 30 ROCKEFELLER PLAZA, NEW YORK, NY, 10112, US

(21) Appl. No.: 09/832,978

(22) Filed: Apr. 12, 2001

(30) Foreign Application Priority Data
Apr. 13, 2000 (JP) 2000-112357

(51) Int. Cl. H01B 13/00

(52) U.S. Cl. 216/17; 216/41; 216/66

(57) ABSTRACT

To provide a dry etching method that attains a high selectivity to a mask and a high etch rate simultaneously, in the steps of forming an intermediate layer and a patterned resist layer on an organic film and etching the organic film using a plasma of a gas containing either of nitrogen and hydrogen, a metal or a metal nitride is used as a part of the intermediate layer.

### BACKGROUND OF THE INVENTION

1. Field of the Invention

The present invention relates to a method of producing an element such as LSI, display element and micromechanics element and a method of etching an organic film used therefor and in particular to a method of etching an organic film of a low dielectric constant (hereinafter referred to “organic low-dielectric-constant film”) called Low-k film.

2. Related Background Art

Methods of producing elements such as LSI, display element and micromechanics element include a film forming step and a film etching step.

To take an LSI producing step as an example, not only reduction in resistance of a conductor forming a wiring part but also reduction in dielectric constant of an insulator is also required to meet the requirements of the element micromachining recently demanded.

Such being the case, fluorine-doped silicon oxide with a dielectric constant of 3.5 to 4.0 is used in place of silicon oxide with a dielectric constant of 3.9 to 4.5 as an insulator and further an organic low-dielectric-constant film with a dielectric constant of 2.4 to 3.4 has come to be used.

Now, referring to FIGS. 6A to 6D, the etching step of the prior art organic low-dielectric-constant film will be described. Reference Numeral 1 denotes a resist mask, Reference Numeral 2 an SiO₂ film formed by the CVD or coating process, Reference Numeral 3 an organic low-dielectric-constant film, for example, made of an organic polymer with a dielectric constant of 3 or lower, Reference Numeral 4 a metal wire, Reference Numeral 5 a wire groove or via hole and Reference Numeral 6 a side wall protective film.

A sectional view of a structure on a wafer prior to etching is shown in FIG. 6A. Stacked on the metal wire 4 are an organic low-dielectric-constant film 3 and an SiO₂, SOG or the like film 2 to be used as a hard mask, on which a mask pattern is formed using a photoresist. Here, as an example of an organic low-dielectric-constant film, a film of a polyaryl ether (FIG. 7) or fluorinated polyaryl ether (FIG. 8) is used. To the above structure, first, a fluorocarbon based gas (e.g. C₄F₈/Ar) is used to etch the hard mask 2 as shown in FIG. 6B. Next, as shown in FIG. 6C, an O₂ based or N₂/H₂ based gas is used to etch the organic low-dielectric-constant film 3. Finally, to remove a residual photoresist mask 1 and the side wall protective film 6, cleaning is carried out to obtain the structure shown in FIG. 6D.

As described above, in etching of an organic low-dielectric-constant film, the main components of the photoresist mask 1 and the organic low-dielectric-constant film 2 are both organic substance and it is difficult to secure the selectivity enough to maintain the etching shape, so that the so-called hard mask method is generally used in which a photoresist pattern is transferred once to an inorganic film 2 such as SiO₂ film and an organic low-dielectric-constant film 3 is etched with the inorganic film 2 employed as the mask.

However, in some cases, the etch selectivity between a SiO₂ film as the hard mask and an organic low-dielectric-constant film has not become sufficiently large and the shape after etching has not been as expected.

Especially, in an attempt to attain high-speed etching, this problem becomes noteworthy.

### SUMMARY OF THE INVENTION

It is an object of the present invention to provide a method of etching an organic film and a method of producing an element enabling etching for obtaining a desired shape to be carried out at a high speed.

It is another object of the present invention to provide a method of etching an organic film and a method of producing an element giving a high selectivity to a hard mask.

According to the present invention, there is provided a method of etching an organic film comprising the steps of forming an intermediate layer and a patterned resist layer on an organic film and etching the intermediate layer exposed from the resist layer, then etching the organic film using a plasma of a gas, wherein the intermediate layer comprises a layer comprised of a metal or metal compound.

### BRIEF DESCRIPTION OF THE DRAWINGS

FIGS. 1A, 1B, 1C, 1D and 1E are schematic sectional views showing the etching method and element producing method according to the present invention;

FIG. 2A is a graphical representation showing the Vpp dependence of the etch rate of an organic film, FIG. 2B is a graphical representation showing the Vpp dependence of the etch rate of a hard mask, and FIG. 2C is a graphical representation showing the Vpp dependence of the etch selectivity;

FIG. 3 is a sectional view of a hole in an element;

FIG. 4A is a graphical representation showing the Vpp dependence of the etch rate of a hard mask, and FIG. 4B is a graphical representation showing the Vpp dependence of the etch selectivity;

FIGS. 5A, 5B and 5C are schematic sectional views showing the etching method and element producing method according to the present invention;

FIGS. 6A, 6B, 6C and 6D are schematic sectional views showing the prior art etching method;

FIG. 7 is a view showing the structural formula of an polyaryl ether; and

FIG. 8 is a view showing the structural formula of a fluorinated polyaryl ether.

### DETAILED DESCRIPTION OF THE PREFERRED EMBODIMENTS

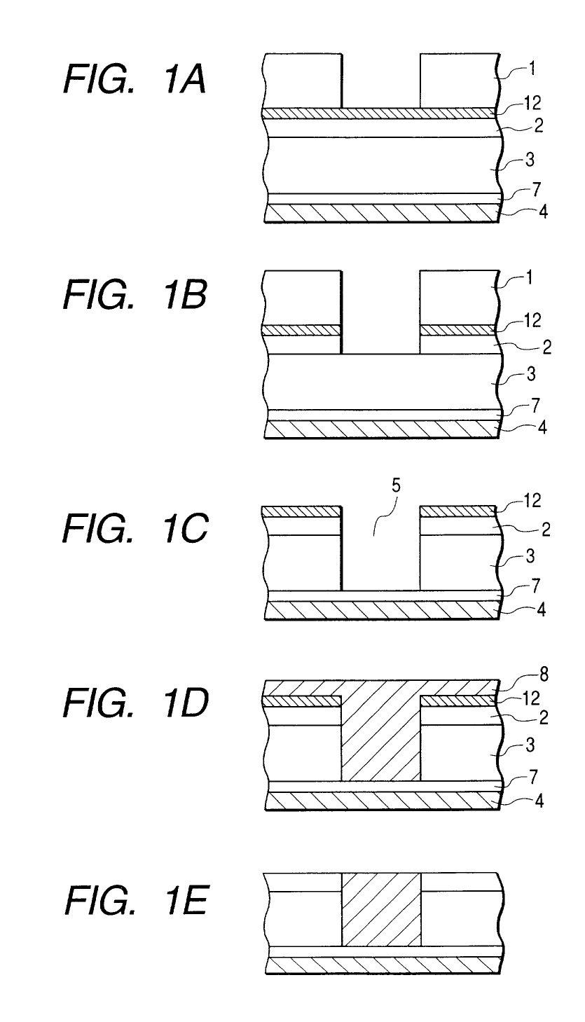

Referring to FIGS. 1A to 1E, the method of etching an inorganic film and method of producing an element according to the present invention will be described.

First, after forming an element such as a transistor on a substrate made of Si or the like depending on to the need, a first layer metal wire 4 comprising Al, a stack of Cu and TiN, or the like is formed.

Then, as needed, a stopper film 7 made of silicon nitride or the like is formed.

Subsequently, an organic insulating film 3 is formed by a coating process or the like.

Then, an SiO₂ film 2 is formed by a CVD process, coating process, or the like.

Furthermore, a metal film 12 for the hard mask is formed by the sputtering process, CVD process, or the like.

A photoresist material, after coated on the metal film 12 and baked, is exposed to ultraviolet light from a KrF eximer laser, an ArF eximer laser, F₂ eximer laser or the like and developed to form a resist mask 1. In this manner, the structure shown in FIG. 1A is obtained. Here, the metal film 12 and the SiO₂ film 2 form the intermediate layer.

Next, the intermediate layer exposed from the resist mask 1 is etched. More specifically, after the etching of the metal film 12 using the resist mask 1, the exposed SiO₂ film is etched. In this manner, the structure shown in FIG. 1B is obtained. FIGS. 1A to 1E are depicted with the side wall protective film being omitted.

Then, the exposed organic insulating film 3 is etched. Furthermore, the underlying stopper film 7 is etched to expose the first layer metal wire 4. In this manner, the structure shown in FIG. 1C is obtained. After the completion of etching of the organic film 3 and the stopper film 7, hardly any of the resist mask remains as shown in FIG. 1C. If the resist mask or the residue thereof remains thinly, it has only to be removed.

According to the organic-film etching method of this embodiment, a desired etching shape can be obtained at a high speed by using the metal film 12 as the intermediate layer.

As the metal film 12, a pure metal comprising at least one selected from aluminium (Al), copper (Cu), titanium (Ti), cobalt (Co), tantalum (Ta), platinum (Pt), tungsten (W), chromium (Cr), etc. or an alloy thereof may be used. Alternatively, a silicate or nitride of the metal selected from them may also be used. Specifically, tantalum nitride (TaN), titanium nitride (TiN), tungsten nitride (WN), titanium silicon nitride (TiSiN), tantalum silicon nitride (TaSiN), tungsten silicon nitride (WSiN), or the like is referred.

Above all, a metal or a metal compound that can be dry-etched using an etching gas is preferably used.

Furthermore, after the formation of a barrier metal such as titanium nitride, etc. as needed, a conductor such as tungsten, copper or the like is deposited and the wire groove or opening formed by the etching is filled with the conductor. In this manner, a conductor 8 for the second layer wiring is formed.

Further, when the conductor 8 remaining above the organic insulating film 3 is removed as the occasion demands, the conductor 8 remains only in the groove or opening 5 as shown in FIG. 1E.

According to the element producing method of this embodiment, a desired shape of structure of wires or electrodes can be obtained.

As the organic insulating film 3 used in the present invention, there may be included a material with a dielectric constant (or permittivity or relative permittivity) lower than that of silicon oxide, preferably not higher than 3.4 and more preferably not higher than 3.0 in dielectric constant. Specifically, the above mentioned fluorinated polyaryl ether or non-fluorinated polyaryl ether is preferably used.

As the gas for etching the organic insulating film 3 used in the present invention, an oxygen-containing gas, a hydrogen-containing gas, or the like is referred, but for the reason mentioned below, a nitrogen- or hydrogen-containing gas is preferably used.

As the nitrogen- or hydrogen-containing gas, N₂ gas, H₂ gas, NH₃ gas, N₂H₂ gas, or a mixed gas of N₂ and H₂ is used, each of which may be used together with a rare gas, if necessary.

Besides, in the present invention, an inorganic insulating film such as a fluorine-doped SiO₂ or SiC film may be used in place of the SiO₂ film that forms the intermediate film.

As the stopper film 7, an inorganic insulating film such as silicon oxide or the like may be used in place of the SiN film.

As the conductor 8, a pure metal comprising at least one selected from tungsten, copper and aluminium formed by a method such as CVD, sputtering, plating or others or an alloy thereof may preferably be used, and at the interfaces of the conductor 8 with the respective layers 12, 2, 3, 7 and 4, at least one layer of a material selected from TiN, TaN, WN, Ti, Ta, TiSiN, TaSiN, etc. serving as a barrier metal may be interposed.

An organic low-dielectric-constant insulating film is known to be etchable by a plasma of an oxygen-containing gas. For example, when a plasma of O₂ gas or CO₂ gas is used, as disclosed in Japanese Patent Application Laid-Open No. 8-316209, most of organic low-dielectric-constant insulating films can be easily etched at high etch rates. However, as described also in Extended Abstracts 15p-C-10 of the 59th Autumn Meeting, 1998 of the Japan Society of Applied Physics, an organic substance reacts not only with oxygen ions but also with oxygen radicals to promote isotropic etching, so that the sectional shape of a hole or groove is likely to become a barrel-like shape referred to as “bowing shape”. If such a shape is formed, poor embedding of a metal into the hole or groove may occur in the subsequent film forming step of a wiring metal, thereby causing disadvantages such as an increase in wiring resistance or breakage of a wire at the worst.

Furthermore, as another demerit of etching by an oxygen plasma, there is a problem of deterioration in film quality, for example, as described in Proceedings of Symposium on Dry Process (1998), p. 175. Namely, the problem is that an organic low-dielectric-constant insulating film exposed to an oxygen plasma may absorb oxygen or form a deteriorated layer containing OH groups through bonding with oxygen, and the oxygen may be desorbed during the subsequent wiring metal forming step, e.g. a CVD step of a tungsten plug to occur poor embedding in a hole or groove.

To solve the above problem, a method using a plasma of an NH₃ gas is disclosed in Japanese Patent No. 2786198. Use of an NH₃ plasma completely eliminates the deterioration in the film quality of an organic film due to the above mentioned oxygen absorption. However, as a problem due to the use of an NH₃ plasma, insufficient selectivity to an SiO₂ based film that has so far been used as the hard mask is included.

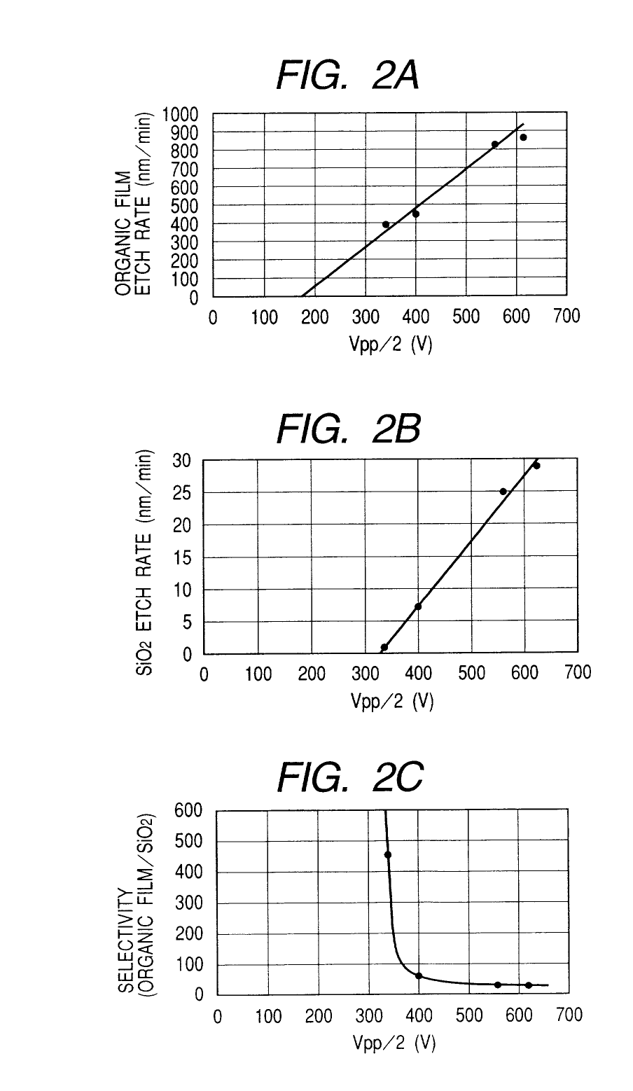

FIGS. 2A to 2C show Vpp independence of the etch rates of an organic low-dielectric-constant film and an SiO₂ film in an NH₃ plasma in the case of using a surface -wave interfered plasma system (hereinafter, referred to as SIP). As an SIP, the system disclosed in Japanese Patent Application Laid-Open No. 11-40397, U.S. patent application Ser. No. 082,006 filed on May 20, 1998 or the like may be used. The term “Vpp” as used herein means a peak-to-peak voltage of a high frequency bias applied to a substrate. When a high frequency bias of not higher than 2 MHZ frequency is applied to the substrate, electrons are accelerated during a half period at the positive side and ions are accelerated during a half period at the negative side. In other words, Vpp/2 means a maximum value of the voltage for accelerating ions or electrons in a plasma. For example, a case where Vpp/2 is 600 V means that ions are incident on the substrate with a maximum energy of 600 eV.

In the figures, FIG. 2A shows the Vpp dependence of the etch rate of an organic low-dielectric-constant film, FIG. 2B the Vpp dependence of the etch rate of an SiO₂ film, and FIG. 2C the Vpp dependence of the etch selectivity.

The maximum of etch rate of the organic low-dielectric-constant film shown in FIG. 2A depends on the plasma density. When a helicon plasma source for a high-density plasma is used, the maximum etch rate is about 300 nm/min, and even if any more high-frequency power is supplied, the etch rate does not increase. Even when an inductively coupled plasma (ICP) source is used, an etch rate of 400 nm/min at the highest is obtained. However, when an SIP source is used, as high a plasma density as 800 nm/min or more can be attained. This means that the SIP system attains a far higher plasma density than other systems.

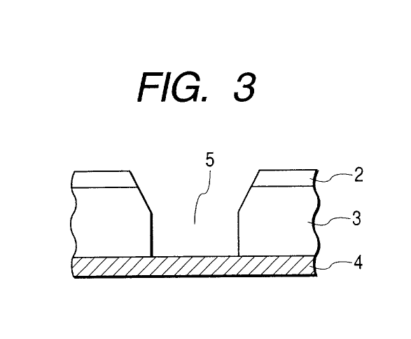

However, as is seen from FIG. 2C, even when using an SIP, if an attempt is made to elevate the etch selectivity of an organic insulating film to an SiO₂ film as a hard mask up to 100 or more which is enough for maintaining the shape, the value of Vpp/2 needs to be lowered to 400 V or less, so that the etch rate may lower to about 400 nm/min, which is insufficient for practical use. On the other hand, if an attempt is made to attain an etch rate of 800 nm/min which is enough for practical use, the etch selectivity to an SiO₂ film as a hard mask lowers down to about 30 to give rise to widening of the diameter of the opening due to the facetting of the hard mask as shown in FIG. 3.

As described above, since deterioration in film quality due to the adsorption of oxygen to an organic low-dielectric-constant insulating film is inevitable in the case of using a plasma of an oxygenic gas, abnormal film formation might occur because of the desorption of oxygen during the subsequent film forming process for a conductor such as a tungsten plug.

Besides, in case of using an NH₃ based plasma, high-speed etching lowers the selectivity to an SiO₂ as the hard mask, thus inducing collapse of the etching shape, so that etching of an organic insulating film at a high selectivity to SiO₂ may lead to an insufficient value of the etch rate for practical use.

Thus, in order to attain both a higher selectivity to a mask and a higher etch rate at the same time, it is preferable to adopt the dry etching method using a metal or a metal nitride as a part of an intermediate layer in the steps of forming an intermediate layer and a patterned resist layer on an organic low-dielectric-constant film, transferring the pattern of the photoresist to the intermediate layer and using a plasma of a gas containing either of nitrogen and hydrogen to etch the organic low-dielectric-constant film.

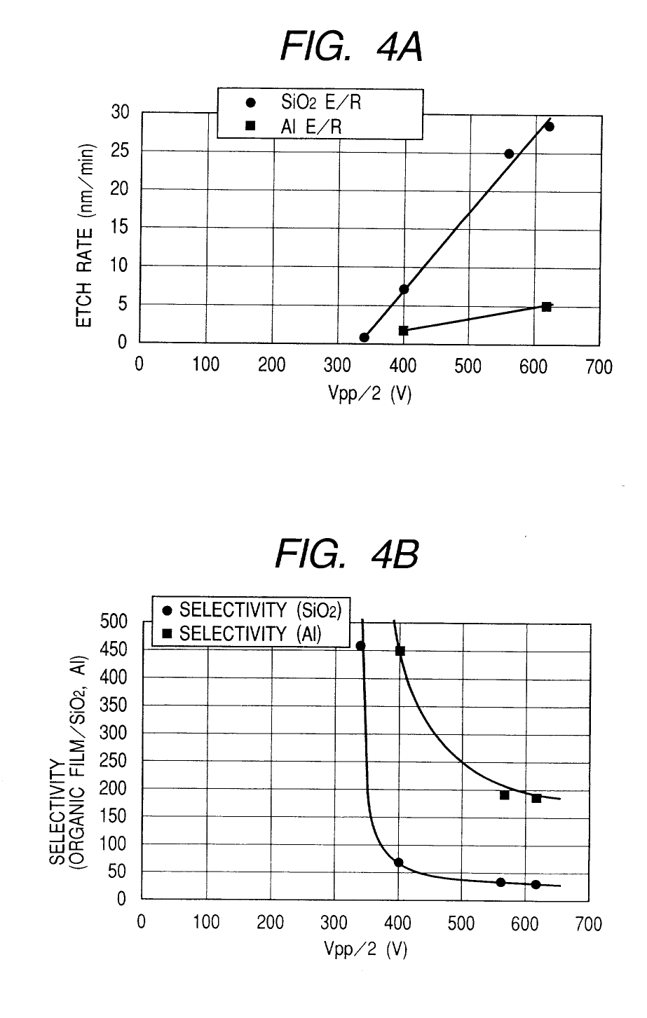

FIG. 4A shows the Vpp dependence of the etch rates (referred to as “E/R”) of SiO₂ and Al with NH₃ gas by use of an SIP, and FIG. 4B shows the Vpp dependence of the etch selectivities of an organic low-dielectric-constant film to each of SiO₂ and Al with NH₃ gas by use of an SIP. It is seen from FIG. 4A, that the Al etch rate is not greater than ⅕ of the SiO₂ etch rate and the etch rate is about 5 nm/min even under the condition of Vpp/2 being about 600, which is a value close to the Ar sputtering rate. Namely, whereas the etching of Al with an NH₃ plasma is a perfect sputtering reaction with ions, it is highly probable that a certain chemical reaction may participate in the etching of SiO₂. The above is supported also by the fact that the SiO₂ etch rate with N₂ has some degree of temperature dependence. The reaction mechanism has not yet been clarified, but since both in an N₂ plasma and an NH₃ plasma the etch rate of SiO₂ is greater than the sputtering rate with Ar by a factor of 10 or more, it is highly probable that N atoms may contribute to the etching reaction. Further, as is clearly seen from FIG. 4B, under the condition of Vpp/2 being 600 V, the selectivity near 200 is attained with an Al mask in contrast to the selectivity of about 30 with an SiO₂ mask. This is a selectivity almost equivalent to that with an SiO₂ mask at the Vpp/2 of 350 V and can be said sufficient for the maintenance of the shape.

Consideration based on the results of the above experiments leads to the conclusion that the material most suitable for a hard mask (intermediate layer) in the etching of an organic low-dielectric-constant film using NH₃ gas is a material which is unreactive to an NH₃ plasma and highly suitable to the existing semiconductor production processes. The materials satisfying the above conditions include wiring metals such as Al, Cu, Ti, Co, Ta, Pt, Cr, W, etc. and metal nitrides for the barrier metal such as TiN, WN, TaN, etc. Generally, metal nitrides are high melting point compounds having melting points of 2000° C. or more and are stable at very high temperatures (for example, AlN: 2700° C.; TiN: 3200° C.). Thus, even if a nitride is formed on the surface of a metal during etching, the nitride will remain on the metal surface as a passive film and never vaporize as a reaction product. Further, the metal nitride such as TiN, TaN, etc. will not effect a chemical reaction (nitridation) with nitrogen any more. Namely, it can be said that etching of the above material with an NH₃ plasma is effected only by physical sputtering.

While the more preferred embodiments have been described for use of an NH₃ plasma, a similar effect can be obtained in any gas system as long as an N₂/H₂ based gas is used. As the N₂/H₂ based gas, there may be included a mixed gas of N₂, H₂ and N₂/H₂, N₂H₄ and so on, in addition to NH₃ as mentioned above.

Again, referring to FIGS. 1A to 1E, a preferred embodiment of the present invention will be described. This embodiment is a single damascene process in case of using the above metal film as a hard mask for etching of an organic low-dielectric-constant film. Reference Numeral 1 denotes a resist mask, 12 a metal film for the hard mask (intermediate layer), 2 a CVD-SiO₂ film (intermediate layer), 3 an organic low dielectric-constant film, 7 a stopper SiN film, 4 a first layer metal wire, 5 a wiring groove or via hole and 8 a second layer wiring metal film.

First, after the completion of a fist layer metal wire forming step, the SiN film 7 as a stopper for via hole etching, the organic low-dielectric-constant film 3, the CVD-SiO₂ film 2 and the metal film 12 for the hard mask are formed in sequence, and the photoresist mask 1 is formed thereon (FIG. 1A). The SiN film 7 and the SiO₂ film 2 are formed using the plasma CVD process. Besides, the organic low-dielectric-constant film 3 is formed by the spin coating process. Since the metal film 12 in use for the hard mask is a film that may be removed afterward and is therefore not limited in its characteristics such as orientation property and resistivity of the film, it can be formed by use of any film forming process including sputtering, CVD, evaporation, or the like. Besides, in cases where it is difficult to form a fine photoresist pattern because of the reflection from the metal surface, an antireflection film may be formed as the occasion demands.

Next, with the resist 1 employed as the mask, etching of the metal film 12 for the hard mask is carried out. As the etching gas, for example, use of a mixed gas of Cl₂/BCl₃ in case of an Al metal film and a fluorine-based gas such as CF₄, SF₆, etc. in case of a Ti or TiN film enables dry etching to be easily carried out.

Next, with the resist 1 and the metal film 12 employed as the mask, etching of the SiO₂ film 2 is carried out. As an etching gas, for example, using a mixed gas of C₄F₈/CO/Ar enables easy etching (FIG. 1B).

Then, using an N₂/H₂ based gas, the organic low-dielectric-constant film 3 is etched under conditions of a high bias voltage (FIG. 1C). At this time, three layers of resist 1/metal hard mask 12/SiO₂ hard mask 2 serves as the mask at the initial stage, while the etch rate of the resist 1 having almost the same main component as the organic insulating film 3 is so fast in the N₂/H₂ based gas that the metal hard mask 12 is exposed during the etching. Here, if the metal hard mask 12 is not provided, the exposed SiO₂ hard mask 2 is etched to generate the abnormal etching shape as shown in FIG. 3. However, the use of the metal hard mask 12 makes the etch rate of the mask 2 very small even under a high Vpp condition, so that no abnormal etching shape due to the facetting of the mask takes place. After the completion of etching of the organic low-dielectric-constant film, the SiN film 7 serving as the etch-stopper is etched using a plasma of a CF₄ based gas. After cleaning the wafer as need, a second layer wiring metal film 8 is formed using the sputtering process, the CVD process, the plating process, or the like (FIG. 1D).

Finally, using an etching or CMP method, the metal film outside the groove is removed. In this case, the metal hard mask 12 is also removed simultaneously (FIG. 1E). At this time, the SiO₂ hard mask 2 acts as the stopper film for the CMP.

While the etching method of the present invention has been described for use of the single damascene process, but it can be applied also to the dual damascene process by repeating the same procedure.

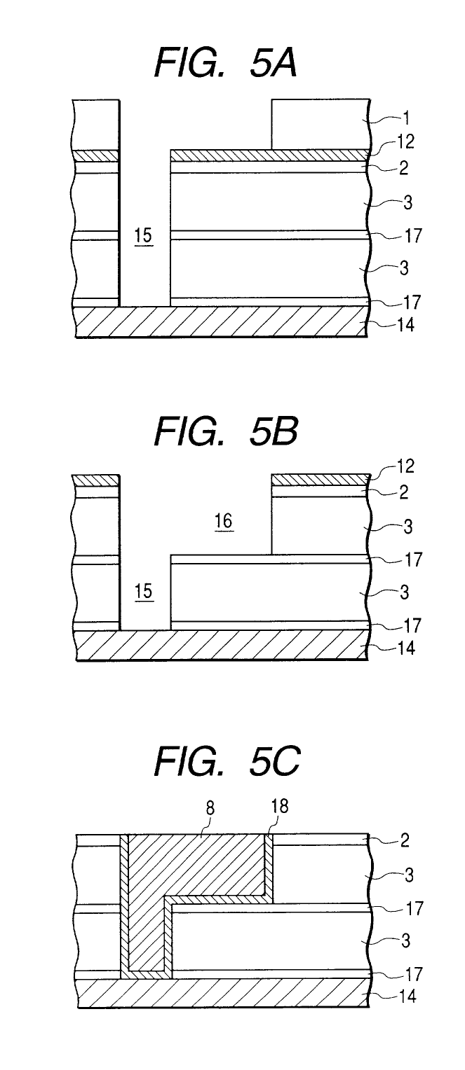

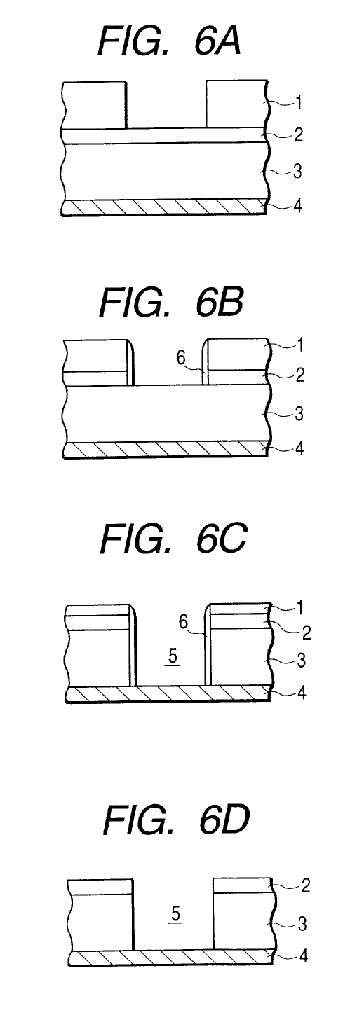

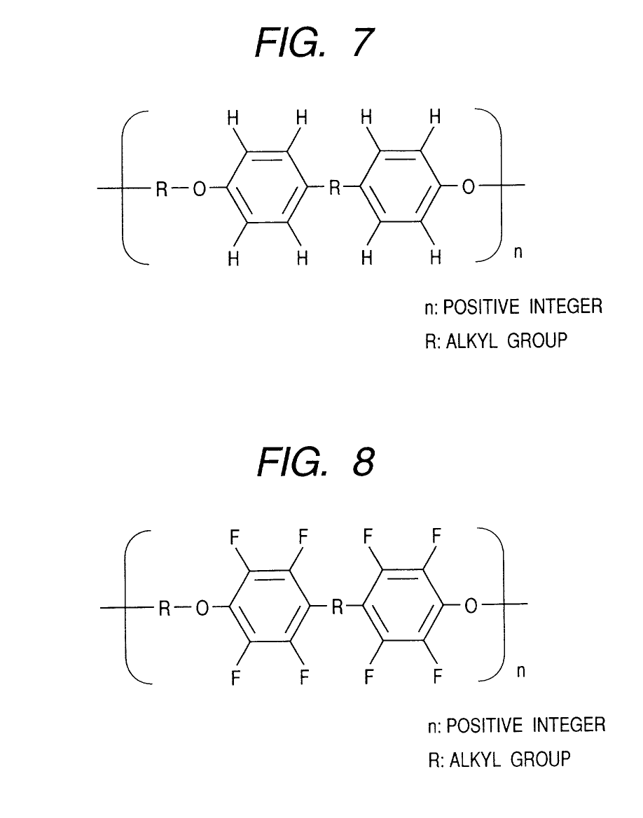

Referring to FIGS. 5A to 5C, an element producing method comprising a wire forming step by the dual damascene process using an etching method according to an embodiment of the present invention will be described.

On a substrate with an element formed thereon, a first metal wiring layer made of W, Cu, a barrier metal or the like, a stopper layer 17 made of SiN, SiO or the like, an organic low-dielectric-constant film 3 and intermediate layers 2 and 12 serving as a hard mask are formed. Further, etching is carried out using a resist mask (not shown) to form a contact hole 15, and a patterned resist mask 1 for formation of a wiring groove 16 is then formed. In this manner, the structure shown in FIG. 5A is obtained.

Further, the metal film 12 as the intermediate layer exposed from the resist mask 1 is removed by etching, and the silicon oxide film 2 as the intermediate layer is then removed by etching.

Furthermore, the organic low-dielectric-constant film 3 is etched away to obtain a structure as shown in FIG. 5B.

After effecting cleaning as the occasion demands, a barrier metal layer 18 is formed by the CVD, the sputtering, or the like. It is preferable to use the same material for both the barrier metal layer 18 and the metal film 12. Then, by the CVD, sputtering or plating, a conductor 8 made of Cu or the like is deposited in the hole 15, in the groove 16 and on the metal film 12.

Thereafter, the metal film 12, the barrier metal and the conductor existing on the silicon oxide film 2 are removed with etching or CMP to leave the conductor 8 only in the hole 15 and the groove 16. In this manner, a structure as shown in FIG. 5C is obtained.

More specific methods of forming and etching individual layers are as described above.

The superiority of the etching method according to the present invention becomes prominent in systems capable of etching an organic low-dielectric-constant film at a high speed. Thus, with a plasma source such as helicon or ICP, the etch rate of an organic low-dielectric-constant film is 400 nm/min at the highest and only a process of the so-called “low rate-high selectivity” can be implemented. Under the conditions of the “low rate-high selectivity”, an etching shape equivalent to that with a hard mask can be implemented even with an SiO₂ hard mask, but there is a serious problem that the etch rate is small. On the other hand, in case of using an SIP, etching at as high a rate as 800 nm/min or higher can be attained, but the SiO₂ hard mask is etched to generate the widening of the aperture of the hole as shown in FIG. 3. Thus, the combination of the conditions for high speed etching with the SIP and used of a metal hard mask can attain both properties of high speed and high selectivity to a mask at the same time.

The organic low-dielectric-constant film is preferably a polyaryl ether or fluorinated polyaryl ether, more preferably a non-fluorinated polyaryl ether. Specifically, “SiLk™” (dielectric constant: 2.65) available from Dow Chemical, Co. and “FLARE™” (dielectric constant: 2.8) available from Honeywell, Co. may preferably be used.

Hereinafter, referring to examples, the plasma processing method according to the present invention will be described in detail, but the present invention is not limited to these examples.

### EXAMPLE 1

As a first example of the present invention, an example of using Al for a metal hard mask is described. As the organic low-dielectric-constant film, a polyaryl ether (available from Honeywell, Co.; Trade Name: FLARE™) was used. First, an 8 inch wafer having the sectional structure shown in FIG. 1A was prepared. The thicknesses of the respective films were as follows: 100 nm for the stopper SiN film; 600 nm for the organic low-dielectric-constant film; 200 nm for the SiO₂ film; 100 nm for the Al film; and 670 nm for the photoresist film. In the photoresist mask, a 0.2 μm hole pattern was formed over the entire surface of the wafer. After the wafer was put into an etching apparatus with a surface-wave interfered plasma (SIP) source (not shown) and the processing chamber was evacuated to 1×10⁻³ Pa, the Al film as the metal hard mask was etched. The etching conditions were as follows.

Gas Species/Flow Rates: Cl₂/BCl₃=60/40 sccm

Pressure: 3 Pa

Microwave Power: 1.5 kW

RF Bias: 300 W

Under the above conditions, the etching was performed for 17 seconds to remove all of the portion exposed from the resist mask of the Al film. The end point of the etching was detected utilizing the light emission (wavelength: 396 nm) of Al. After the detection of the end point of the etching, over-etching of 20% was carried out.

Next, after the wafer was transferred to a separate processing chamber while keeping the vacuum state and the processing chamber was evacuated to 1×10⁻³ Pa, the portion exposed from the resist mask of the SiO₂ film as the hard mask was etched. The etching conditions were as follows.

Gas Species/Flow Rates: C₄F₈/Ar=15/185 sccm

Pressure: 15 Pa

Microwave Power: 1.5 kW

RF Bias Power: 350 W

Under the above conditions, the etching was performed for 30 seconds to etch and remove all of the portion exposed from the resist mask of the SiO₂ film. The end point of etching was detected utilizing the light emission (wavelength: 640 nm) of SiF.

After the completion of the SiO₂ etching, the wafer was transferred to a separate processing chamber while keeping the vacuum state and the processing chamber was evacuated to 1×10⁻³ Pa, then the organic low-dielectric-constant film was etched. The etching conditions were as follows.

Gas Species/Flow Rate: NH₃=200 sccm

Pressure: 1 Pa

Microwave Power: 2.5 kW

Bias Frequency: 1.5 MHz

Bias Power: 600 W

Under the above conditions, the etching was performed for 60 seconds to etch and remove all of the portion exposed from the hard mask of the organic low-dielectric-constant film. The end point of the etching was detected by utilizing the light emission (wavelength: 388 nm) of CN. After the completion of the processing, a section of the wafer was observed by use of an SEM, with the result that no widening of the hole diameter due to the facetting of the hard mask was observed at all.

### EXAMPLE 2

As a second example of the present invention, an example of using TiN for the metal hard mask is described. As the organic low-dielectric-constant film, a polyaryl ether (available from Honeywell, Co.; Trade Name: FLARET™) was used as with Example 1. First, an 8 inch wafer having the sectional structure shown in FIG. 1A was prepared. The thicknesses of the respective films were as follows: 100 nm for the stopper SiN film; 600 nm for the organic low-dielectric-constant film; 200 nm for the SiO₂ film; 120 nm for the TiN film; and 670 nm for the photoresist film. In the photoresist mask, a 0.2 μm hole pattern was formed over the entire surface of the wafer. After the wafer was put into an etching apparatus with an SIP source (not shown) and the processing chamber was evacuated to 1×10⁻³ Pa, the TiN film as the metal hard mask was etched. The etching conditions were as follows.

Gas Species/Flow Rates: Cl₂/BCl₃=30/70 sccm

Pressure: 3 Pa

Microwave Power: 1.5 kW

RF Bias: 450 W

Under the above conditions, the etching was performed for 30 seconds to remove all of the portion exposed from the resist mask of the TiN film.

Next, the wafer was transferred to a separate processing chamber while keeping the vacuum state and the processing chamber was evacuated to 1×10⁻³ Pa, then the SiO₂ film as the hard mask was etched. The etching conditions were as follows.

Gas Species/Flow Rates: C₄F₈/Ar=15/185 sccm

Pressure: 15 Pa

Microwave Power: 1.5 kW

RF Bias Power: 350 W

Under the above conditions, the etching was performed for 30 seconds to remove all of the portion exposed from the resist mask of the SiO₂ film. The end point of the etching was detected utilizing the light emission (wavelength: 640 nm) of SiF.

After the completion of the SiO₂ etching, the wafer was transferred to a separate processing chamber while keeping the vacuum state and the processing chamber was evacuated to 1×10⁻³ Pa, then the organic low-dielectric-constant film was etched. The etching conditions were as follows.

Gas Species/Flow Rate: NH₃=200 sccm

Pressure: 1 Pa

Microwave Power: 2.5 kW

Bias Frequency: 1.5 MHz

Bias Power: 600 W

Under the above conditions, the etching was performed for 60 seconds to remove all of the portion exposed from the hard mask of the organic low-dielectric-constant film. The end point of the etching was detected utilizing the light emission (wavelength: 388 nm) of CN. After the completion of the processing, a section of the wafer was observed by use of an SEM, with the result that no widening of the hole diameter due to the facetting of the hard mask was observed at all.

### EXAMPLE 3

As a third example of the present invention is described an example of using TiN for the metal hard mask and using N₂ gas for the etching. As the organic low-dielectric-constant film, a polyaryl ether (available from Honeywell, Co.; Trade Name: FLARE™) was used as with Example 1. First, an 8 inch wafer having the sectional structure shown in FIG. 1A was prepared. The thicknesses of the respective films were as follows: 100 nm for the stopper SiN film; 600 nm for the organic low-dielectric-constant film; 200 nm for the SiO₂ film; 120 nm for TiN film; and 670 nm for the photoresist film. In the photoresist mask, a 0.2 μm hole pattern was patterned over the entire surface of the wafer. After the wafer was put into an etching apparatus with an SIP source (not shown) and the processing chamber was evacuated to 1×10⁻³ Pa, the TiN film as the metal hard mask was etched. The etching conditions were as follows.

Gas Species/Flow Rates: Cl₂/BCl₃=30/70 sccm

Pressure: 3 Pa

Microwave Power: 1.5 kW

RF Bias: 450 W

Under the above conditions, the etching was performed for 30 seconds to remove all of the portion exposed from the resist mask of the TiN film.

Next, the wafer was transferred to a separate processing chamber while keeping the vacuum state and the processing chamber was evacuated to 1×10⁻³ Pa, then the SiO₂ film as the hard mask was etched. The etching conditions were as follows.

Gas Species/Flow Rates: C₄F₈/Ar 15/185 sccm

Pressure: 15 Pa

Microwave Power: 1.5 kW

RF Bias Power: 350 W

Under the above conditions, the etching was performed for 30 seconds to remove all of the portion exposed from the resist mask of the SiO₂ film. The end point of the etching was detected utilizing the light emission (wavelength: 640 nm) of SiF.

After the completion of the SiO₂ etching, the wafer was transferred to a separate processing chamber while keeping the vacuum state and the processing chamber was evacuated to 1×10⁻³ Pa, then the organic low-dielectric-constant film was etched. The etching conditions were as follows.

Gas Species/Flow Rate: N₂=200 sccm

Pressure: 1 Pa

Microwave Power: 2.5 kW

Bias Frequency: 1.5 MHz

Bias Power: 800 W

Under the above conditions, the etching was performed for 90 seconds to remove all of the portion exposed from the hard mask of the organic low dielectric-constant film. The end point of the etching was detected utilizing the light emission (wavelength: 388 nm) of CN. After the completion of the processing, a section of the wafer was observed by use of an SEM. Judging from the end time of the etching, the etch rate with the N₂ plasma was lower by about 30% than that with the NH₃ plasma, but no widening of the hole diameter due to the facetting of the hard mask was observed at all.

As described above, according to the present invention, the use of a metal or metal compound as the material of the hard mask makes it possible to provide a dry etching method which is free from generation of an abnormal shape such as widening of a hole diameter due to the facetting of a hard mask even when etching an organic low-dielectric-constant film with a plasma of an N₂/H₂ based gas.

What is claimed is:

1. A method of etching an organic film, comprising the steps of:
forming an intermediate layer and a patterned resist layer on an organic film;
etching the intermediate layer exposed from the resist layer; and
then etching the organic film using a plasma of a gas,
wherein the intermediate layer comprises a layer comprised of a metal or metal compound.

2. The method according to claim 1, wherein the metal is aluminium, copper, titanium, cobalt, tantalum, platinum, chromium or tungsten.

3. The method according to claim 1, wherein the metal compound is titanium nitride, tungsten nitride or tantalum nitride.

4. The method according to claim 1, wherein the gas is N₂, H₂, a mixed gas of N₂ and H₂, NH₃ or N₂H₄.

5. The method according to claim 1, wherein the plasma is a surface-wave interfered plasma.

6. The method according to claim 1, wherein the organic film is a polyaryl ether or fluorinated polyaryl ether.

7. The method according to claim 1, wherein the organic film comprises a low-dielectric-constant material having a lower dielectric constant than silicon oxide.

8. The method according to claim 1, wherein the organic film comprises a low-dielectric-constant material having a lower dielectric constant than silicon oxide, and the gas is a gas containing at least one of nitrogen and hydrogen.

9. The method according to claim 1, wherein the intermediate layer comprises an inorganic insulating layer in contact with the organic film.

10. A method of etching an organic film, comprising the steps of:
forming an intermediate layer and a patterned resist layer on an organic low-dielectric-constant film;
etching the intermediate layer exposed from the resist layer; and
then etching the organic low-dielectric-constant film using a plasma of a gas containing either of nitrogen and hydrogen,
wherein the intermediate layer comprises a layer comprised of a metal or metal nitride.

11. A method of producing an element, comprising the steps of:
forming an organic insulating film, an intermediate layer and a patterned resist layer on a substrate;
etching the intermediate layer exposed from the resist layer, and then etching the organic insulating film using a plasma of a gas; and
filling with a conductor a portion where the organic insulating film is etched away,
wherein the intermediate layer comprises a layer comprised of a metal or metal compound.

12. The method according to claim 11, further comprising, after the filling with the conductor, the step of removing the layer comprised of the metal or metal compound.

13. The method according to claim 11, wherein the metal is aluminium, copper, titanium, cobalt, tantalum, platinum, chromium or tungsten.

14. The method according to claim 11, wherein the metal compound is titanium nitride, tungsten nitride or tantalum nitride.

15. The method according to claim 11, wherein the gas is N₂, H₂, a mixed gas of N₂ and H₂, NH₃ or N₂H₄.

16. The method according to claim 11, wherein the plasma is a surface-wave interfered plasma.

17. The method according to claim 11, wherein the organic insulating film is a polyaryl ether or fluorinated polyaryl ether.

18. The method according to claim 11, wherein the organic insulating film comprises a low-dielectric-constant material having a lower dielectric constant than silicon oxide.

19. The method according to claim 11, wherein the organic insulating film comprises a low-dielectric-constant material having a lower dielectric constant than silicon oxide, and the gas is a gas containing at least one of nitrogen and hydrogen.

20. The method according to claim 11, wherein the intermediate layer comprises an inorganic insulating layer in contact with the organic insulating film.
